(19) United States
(12) Patent Application Publication
(10) Pub. No.: US 2016/0095277 A1
(43) Pub. Date: Apr. 7, 2016

(54) MOWER HAVING A CONTINUOUSLY VARIABLE POWER SPLIT DEVICE

(71) Applicant: Textron, Inc., Providence, RI (US)

(72) Inventors: Richard Michael Krzesicki, Charlotte, NC (US); Craig W. Pavlich, Glen Ellyn, IL (US); Christian Bryant, Charlotte, NC (US); Bryan Holby, Clover, SC (US)

(21) Appl. No.: 14/506,069

(22) Filed: Oct. 3, 2014

(51) Int. Cl. A01D 34/47; A01D 43/00

(52) U.S. Cl. CPC A01D 34/475; A01D 43/006

(57) ABSTRACT

A grass mower comprising a power generator, a blade reel, a drive drum, and a power split device. The split power device can include a single power input shaft, a reel output shaft, a drum output shaft, and at least one continuously variable transmission hub operably connecting the reel output shaft and/or the drum output shaft to the power input shaft such that torque and rotational speed delivered by the power input shaft is transferrable to the reel and/or drum output shafts at any infinitely variable ratio. The power split device structured and operable to transfer the torque and rotational speed delivered by the power input shaft to both the reel and drum output shafts such that a rotational speed of the blade reel and a rotational speed of the drive drum are both generated from the power delivered by the power input shaft and are both independently controlled.

### FIELD

The present teachings relate to walk-behind turf care mowers, and particularly to walk-behind turf care mowers having a continuously variable power split device for controlling the frequency-of-clip of such mowers independent of the ground speed of the mower.

### BACKGROUND

The statements in this section merely provide background information related to the present disclosure and cannot constitute prior art.

Walk-behind reel mowers, commonly used for cutting, grooming and maintaining grass at golf courses, sporting venues, parks, consumer lawns, etc., typically include one, or more, reel assembly, sometimes referred to as a head unit, that generally includes a motor, a bedbar assembly, a blade reel and a drive drum. The blade reel comprises a plurality of cutting blades helically disposed about a shaft that is rotationally mounted within a frame of the reel assembly. The drive drum is generally a cylindrical drum that is rotated by the motor to propel the mower along the ground as the blade reel rotates the cutting blades in contact with a bedknife blade of the bedbar assembly to cut the grass.

A frequency of clip (FOC) is an important consideration when maintaining many grass surfaces, such as golf course greens. The FOC is generally measured by the distance the mower travels forward before the next cutting blade reaches the bedknife blade. Different climates, grasses, weather conditions, and desired height and quality of cut require different clip frequency settings. In a traditional, fixed-ratio mower, the ratio of the speed of the blade reel to the ground speed of the mower (i.e., the rotational speed of the drive drum) is typically not adjustable, or limited to a fixed set of adjustments. Often, in order to change the FOC, the blade reel must be removed and replaced with another reel unit having a greater or lesser number of cutting blade. Such limitations can result in the undesirable conditions of sub-optimal FOC settings, reduced productivity and/or increased consumption of time.

Advances have been made to overcome the shortcomings of the fixed ratio mower. For example, mowers have been constructed that utilize two separate motors, e.g., DC electric motors, wherein each motor rotates a separate one of the drive drum and the blade reel. Although such systems overcome some of the limitations of the fixed ratio mowers, such systems incur significant penalties in cost, weight and complexity related to the additional components and structural configuration.

### SUMMARY

The present disclosure provides a walk-behind grass mower structured and operable to distribute torque and rotational speed input from a single power generator, to each of a drive drum and a blade reel of the mower at independently controllable torque transfer ratios. In various embodiments, the mower comprises a power generator, a blade reel, a drive drum, and a power split device. The split power device can include a single power input shaft, a reel output shaft, a drum output shaft, and at least one continuously variable transmission hub operably connecting the reel output shaft and/or the drum output shaft to the power input shaft such that torque and rotational speed delivered by the power input shaft is transferrable to the reel and/or drum output shafts at any infinitely variable ratio. The power split device can be structured and operable to transfer the torque and rotational speed delivered by the power input shaft to both the reel and drum output shafts such that a rotational speed of the blade reel and a rotational speed of the drive drum are both generated from the power delivered by the power input shaft and are both independently controlled.

Further areas of applicability of the present teachings will become apparent from the description provided herein. It should be understood that the description and specific examples set forth in this disclosure are intended for purposes of illustration only and are not intended to limit the scope of the present teachings.

### DRAWINGS

The drawings described herein, which are not necessarily drawn to scale, are for illustration purposes only and are not intended to limit the scope of the present teachings in any way.

FIG. 1 is an isometric view of an exemplary walk-behind reel mower including a power split device for distributing torque input from a single engine or motor to each of a drive drum and a blade reel of the mower at independently controllable torque transfer ratios, in accordance with various embodiments of the present disclosure.

FIG. 2A is a schematic of the mower shown in FIG. 1 exemplarily illustrating the engine, drive drum, blade reel and power split device, in accordance with various embodiments of the present disclosure.

FIG. 2B is a block diagram of the mower shown in FIG. 1 exemplarily illustrating the engine, drive drum, blade reel and power split device, in accordance with various embodiments of the present disclosure.

FIG. 3 is an exemplary illustration of a power split device controller and user interface of the mower shown in FIG. 1, in accordance with various embodiments of the present disclosure.

FIG. 4 is a schematic of the mower shown in FIG. 1 exemplarily illustrating the power split device in accordance with various embodiments of the present disclosure.

FIG. 5 is a schematic of the mower shown in FIG. 1 exemplarily illustrating the power split device in accordance with other various embodiments of the present disclosure.

FIG. 6 is a flow chart illustrating processes carried out by the power split device controller, in accordance with various embodiments of the present disclosure.

FIG. 7 is a flow chart illustrating processes carried out by the power split device controller, in accordance with various other embodiments of the present disclosure.

FIG. 8 is a flow chart illustrating processes carried out by the power split device controller, in accordance with yet other various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

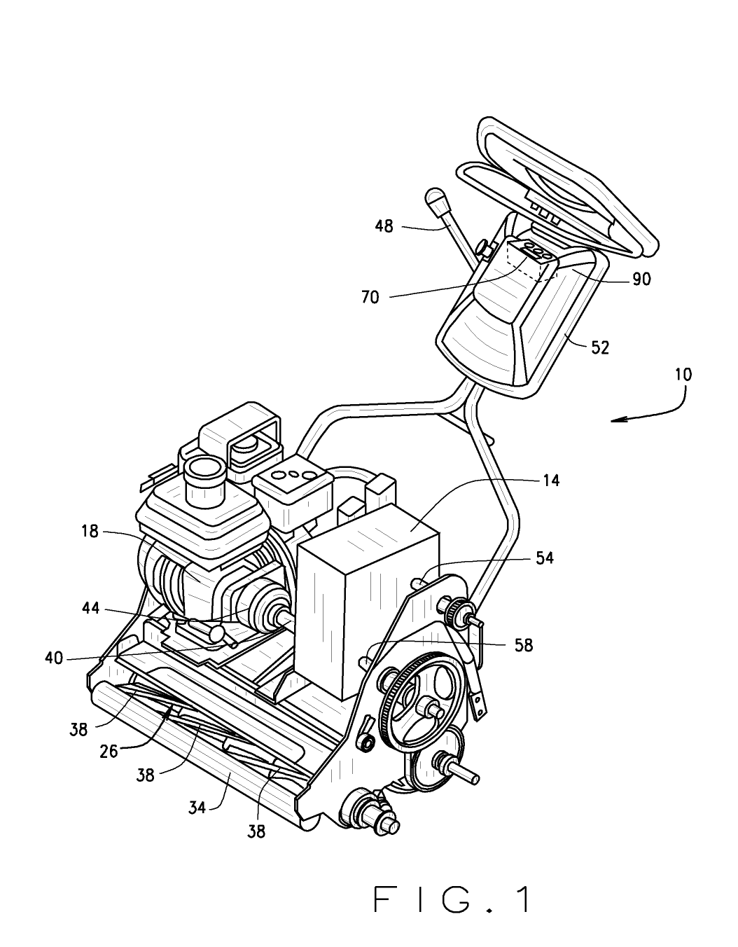

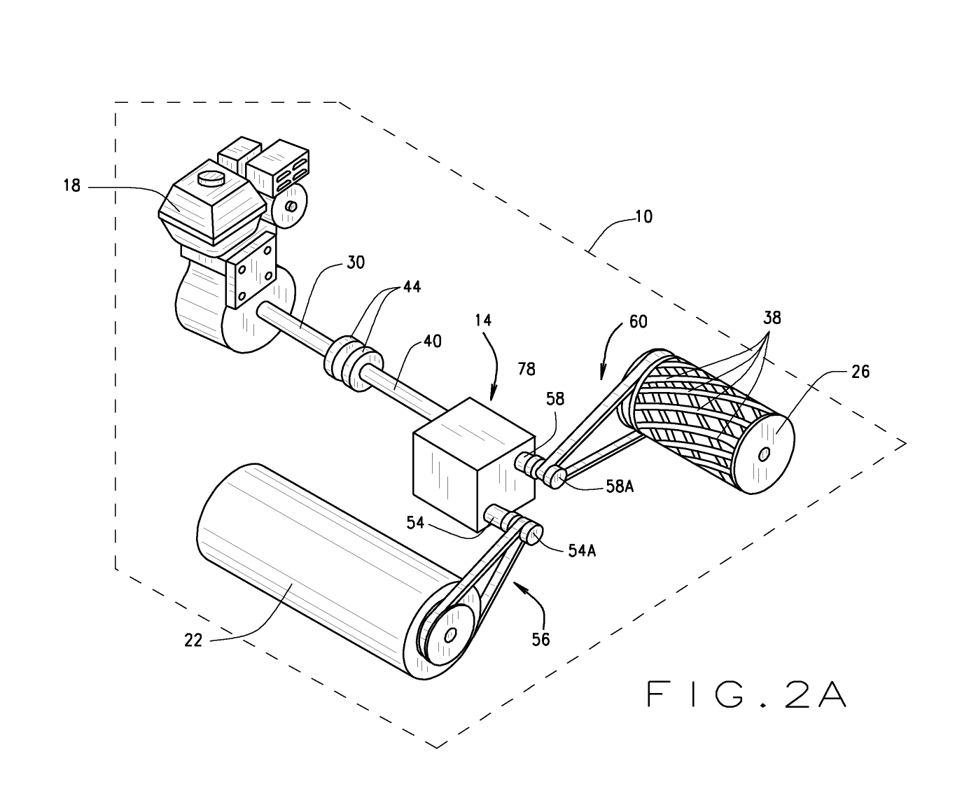

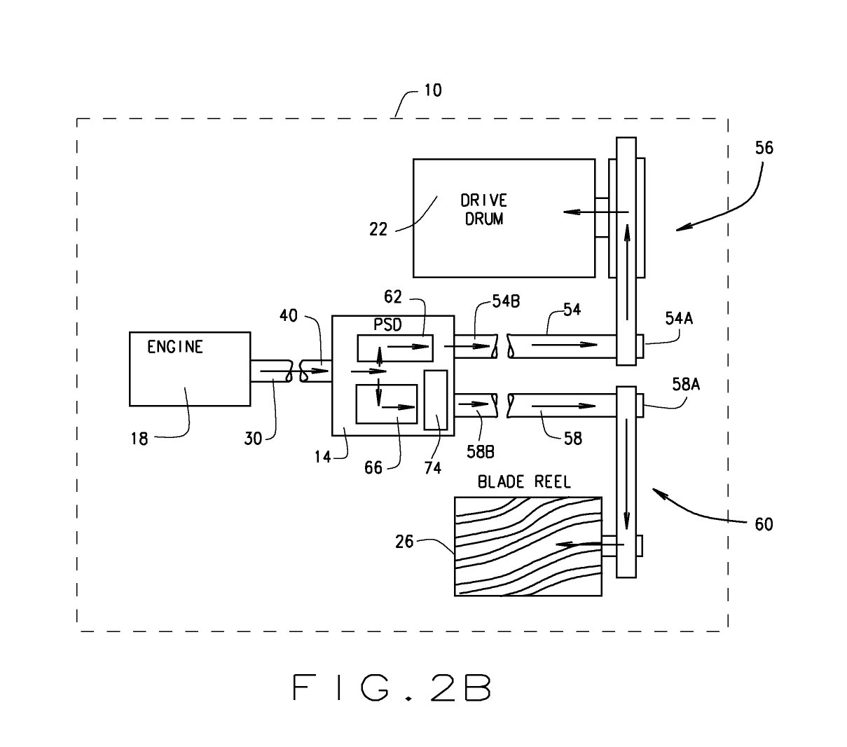

Referring now to FIG. 1, the present disclosure provides a walk-behind reel mower 10 including a power split device 14 that is structured and operable to distribute torque and rotational speed input from a single power generator 18, to each of a drive drum 22 and a blade reel 26 of the mower 10 at independently controllable torque transfer ratios. The power generator 18 can be any device structured and operable to generate and deliver torque and rotational speed, via a power generator shaft 30 (shown in FIGS. 2A and 2B), such as an internal combustion engine (ICE), an electric motor, e.g., a DC induction motor, or any other suitable torque generating/delivering device.

Generally, when the mower 10 is in operation, the drive drum 22 is in contact with the ground and is rotated, or driven, via torque generated by the power generator 18 to propel the mower 10 across the ground at a desired rate of travel (e.g., feet/second) that is controlled by the rotational or angular speed of the drive drum 22. The rotational speed of the drive drum 22, and hence the rate of forward travel of the mower 10, is controlled by operation of the power split device 14, as described below. Additionally, when the mower 10 is in operation, a front roller bar 34 of the mower 10 is adjusted to set the blade reel 26 and a bedknife blade (not shown) of the mower 10 at a desired cut height above the ground, e.g., 0.25 to 0.75 inches, and the blade reel 26 is rotated, or driven, via power generated by the power generator 18 at a desired rotational speed. The rotational speed of the blade reel 26 is controlled by operation of the power split device 14, as described below.

More particularly, the blade reel 26 is rotated to rotate a plurality of grass cutting blades 38, of the blade reel 26, past the bedknife blade, whereby grass will be caught between the rotating cutting blades 38 and a bedknife blade and cut/clipped to the set cut height. The rotational speed of the blade reel 26 is controlled by operation of the power split device 14, independent from the control of the rotational speed of the drive drum 22, as described below. More particularly, the power split device 14 receives a single input rotational speed from the power generator 18 and outputs rotational speed to the drum drive 22 at any selected torque input-to-output ratio, and to the blade reel 26 at any selected torque input-to-output ratio such that the rotational speed of the drive drum 22 and the blade reel 26 can be independently controlled. Accordingly, via the power split device 14, the mower 10 can be operated to provide any desired frequency of clip (FOC), which is a function of forward travel speed of the mower 10. More particularly, the power split device 14 controls the FOC by independently controlling input-to-output torque ratios to the drive drum 22 and the blade reel 26 utilizing a single input rotational speed provided by the power generator 18, thereby independently controlling the rotational speed of the drive drum 22 and the blade reel 26. The torque input-to-output ratio will sometimes be referred to herein as torque transfer ratios.

Referring now to FIGS. 1, 2A and 2B, the power split device 14 comprises a single power input shaft 40 that is operably connectable to the power generator shaft 30. In various implementations, the power input shaft 40 is connectable, or engageable, to or with the power generator shaft 30 via a power generator clutch mechanism 44. The power generator clutch mechanism 44 can be any suitable mechanical, electrical or electromechanical clutch mechanism structured and operable to manually or automatically engage and disengage the power generator shaft 30 with and from power input shaft 40. For example, in various implementations, the power generator clutch mechanism 44 can be a mechanical clutch mechanism operated, i.e., selectably engageable and disengageable, using a clutch control device 48 (e.g., a bail lever) located on a control column 52 of the mower 10 and operatively connected (e.g. connected via cables and/or mechanical linkage) to the power generator clutch mechanism 44.

The power split device 14 additionally comprises a drum output shaft 54 operably connected at a distal end 54A to the drive drum 22 and a reel output shaft 58 operably connected at a distal end 58A to the blade reel 26. The drum output shaft 54 and the reel output shaft 58 can respectively be operatively connected to the drive drum 22 and the blade reel 26 using any suitable power transfer mechanism, device or system, 56 and 60, e.g., a gear set, a geared transmission, a series of pulleys and belts, etc. Furthermore, the power split device 14 comprises a drum torque transfer assembly 62 that operably connects a proximal end 54B of the drum output shaft 54 to the power input shaft 40 and is structured and operable to transfer power from the input shaft 40 to the drum output shaft 54 at any selected torque transfer ratio. Still further, the power split device 14 comprises a reel torque transfer assembly 66 that operably connects a proximal end 58B of the reel output shaft 58 to the power input shaft 40 and is structured and operable to transfer power from the input shaft 40 to the reel output shaft 58 at any selected torque transfer ratio, independently from the operation of the drum torque transfer assembly 62.

The power split device 14 is communicatively connected (e.g., wired and/or wirelessly) to a power split device controller 70, described further below. Specifically, the controller 70 controls operation of the power split device 14, and particularly the operation of the drum torque transfer assembly 62 and the reel torque transfer assembly 66, such that the drum torque transfer assembly 62 and the reel torque transfer assembly 66 are independently controlled. More specifically, the torque transfer ratios of the power delivered by the power generator 18 to both the drum torque transfer assembly 62 and the reel torque transfer assembly 66 are independently controlled. Therefore, the rotational, or angular, speed of the drive drum 22 and the blade reel 26 are produced via the single power generator 18 and are independently controlled via the power split device 14 and controller 70, such that the mower 10 can be operated at any desired forward travel speed and at any desired FOC.

Referring now to FIGS. 1, 2A, 2B, 4 and 5, importantly, at least one of the drum torque transfer assembly 62 and the reel torque transfer assembly 66 is a continuously variable transmission (CVT) hub, whereby torque delivered by the power input shaft 40 is transferred to the drum and/or reel output shafts 54 and/or 58 at any selectable infinitely variable torque input-to-output ratio. Each CVT hub provides a mechanical coupling between the power input shaft 40 and the respective drum output shaft 54 and/or the reel output shaft 58. Particularly, each CVT hub is capable of varying the rotational speed transferred by, or delivered from, the power input shaft 40 to the respective drum output shaft 54 and/or the reel output shaft 58 in infinitesimal step sizes over a specific range of torque. Consequently, each CVT hub is capable of varying the rotational, or angular, speed of the respective drive drum 22 and/or blade reel 26 independently from each other. That is, although both the drive drum 22 and the blade reel 26 are driven/rotated utilizing power generated by the single power generator 18, the operation of the drum torque transfer assembly 62 (and hence, the rotational speed of the blade reel 26) is controlled independently from the operation of the reel torque transfer assembly 66 (and hence, the rotational speed of the drive drum 22), and vice-versa.

Each CVT hub comprises a housing and, internally disposed therein, any CVT power transfer mechanism structured and operable to provide a continuous (theoretically infinite) variety of torque input-to-output ratios, including but not limited to; planetary gear sets coupled to electric actuators (sometimes referred to as electrically-variable CVTs or E-CVTs), steel or rubberized belts coupled to variable geometry pulleys (sheaves), or by employing other techniques such as the combination of spherical bearings and non-Newtonian fluids.

In various embodiments, the power split device 14 includes a reel clutch mechanism 74 structured and operable to engage and disengage the delivery of power from the power input shaft 40 to the reel output shaft 58. In various implementations, the reel clutch mechanism 74 can be any suitable mechanical, electrical or electromechanical clutch mechanism structured and operable to manually or automatically engage and disengage the real output shaft 58 with and from the reel torque transfer assembly 74. Alternatively, the reel clutch mechanism 74 can be any suitable mechanical, electrical or electromechanical clutch mechanism structured and operable to manually or automatically engage and disengage the reel torque transfer assembly 66 with and from the power input shaft 40. In various embodiments, the power split device 14 includes a housing 78 that encloses the drum torque transfer assembly 62, the reel torque transfer assembly 66 and the reel clutch mechanism 74. The reel clutch mechanism 74 can be used to disengage the blade reel 26 from power delivered from the power input shaft 40 when the mower 10 is not being used to cut grass, but is merely being conveyed from one cutting surface to another.

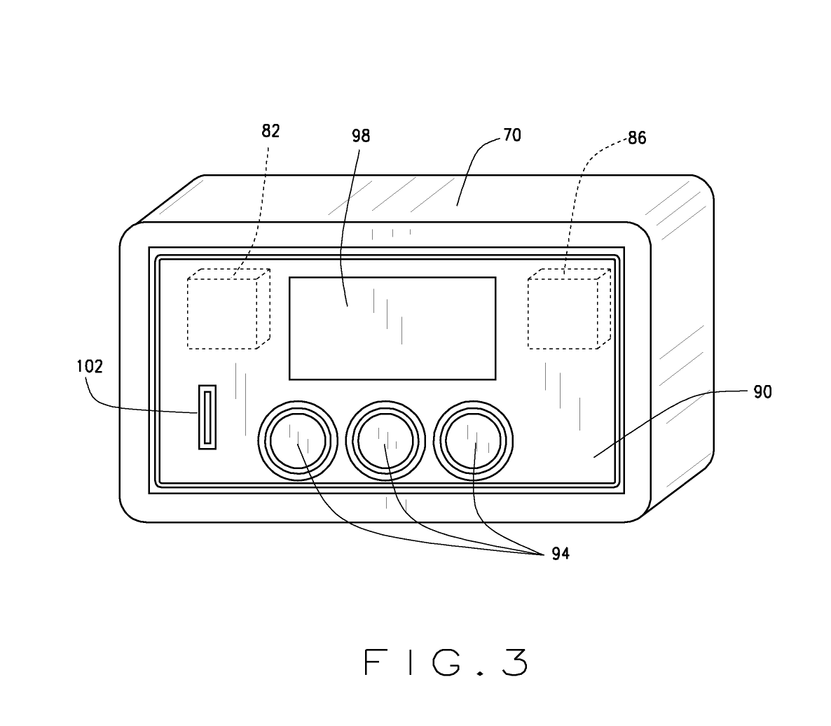

Referring now to FIGS. 1 and 3, in various embodiments, the power split device controller 70 is a computer based controller that is communicatively coupled (e.g., wired and/or wirelessly) to the power split device 70. The controller 70 of various embodiments is programmable and operable to execute one or more torque distribution programs or algorithms (simply referred to herein as torque distribution software) to independently control the drum and reel torque transfer assemblies 62 and 66, in order to independently transfer power from the power input shaft 40 (delivered by the power generator 18, via the power generator shaft 30) to the respective drum and reel output shafts 54 and 58, at any selected input-to-output ratios.

The controller 70 generally includes at least one electronic storage device 82, at least one processor 86, and/or other circuitry suitable for storing and executing the torque distribution software. Each electronic storage device 82 comprises a computer readable medium, such as a hard drive, flash memory, an ASIC or any other electronic data storage device for storing such things as software packages or programs and algorithms (e.g., the torque distribution software), digital information, data, look-up tables, spreadsheets, databases and/or the like that can be used to implement torque distribution control in accordance with various embodiments. The processor(s) 86 is/are operable to execute the torque distribution software. The controller 70 is in operable communication with a user interface 90 that is accessible by the mower operator for selecting a desired FOC and for inputting data used to program the controller 70. In various embodiments, the user interface 90 can included with the controller 70, as exemplarily illustrated in FIG. 3, or alternatively, the user interface 90 can be physically separated and remotely located from the controller 70. In various implementations, the user interface 90 includes a plurality of selection buttons 94 for selecting a desired FOC, and various implementations, for programming the controller 70. In various implementations the user interface 90 can include a display 98 for viewing such things as information, data and/or other graphical representations. Additionally, in various implementations, the user interface 90 can include one or more I/O (input/output) communication interfaces 102 (e.g., USB port(s), Infrared I/O communications port(s) and/or a Bluetooth I/O device(s)) structured and operable for connecting an external device to the controller 70 to download and upload data to and from the electronic storage device 82. Additionally, in various implementations, the controller 70 can be further structured and operable to communicate with external devices utilizing WiFi (e.g., based on an IEEE 802.11 standard), WiFi direct, Zigbee, nearfield communication (NFC), and/or other present or future developed wireless communication technologies.

For example, in various embodiments, an external computer device, e.g., a laptop, tablet, smart phone, or other computer device, can be connected to the controller 70, via the I/O communication interface(s) 102 or wireless communication means described herein, to download the torque distribution software to the electronic storage device 82 and/or to access (or use) the torque distribution software to program the controller 70 with a desired setting. Alternatively, in various embodiments, the controller 70 can be structured and operable such that the selection buttons 94 can be used, independently or in combination with an external computer device to download the torque distribution software to the electronic storage device 82 and/or to access (or use) the torque distribution software to program the controller 70 with a desired setting. Furthermore, in various embodiments, the I/O communication interface(s) 102, or wireless communication means described herein, can also be used to upload information from the controller 70, such as elapsed cutting time for the mower 14 or other desired mower information. It is also envisioned that, in various implementations, the controller 70 is structured and operable to receive feedback data from feedback sensors (not shown) of the mower 10 that are operable to provide feedback regarding the speed of, and more particularly the rotational speed input by the power input shaft 40 and output by the drum and reel output shafts 54 and 58. Additionally, in various implementations, the controller 70 can, via execution of the torque transfer software and in accordance with programmed settings, control the speed of, and more particularly the rotational speed output by, the power generator 18 based on information/data from the feedback sensors.

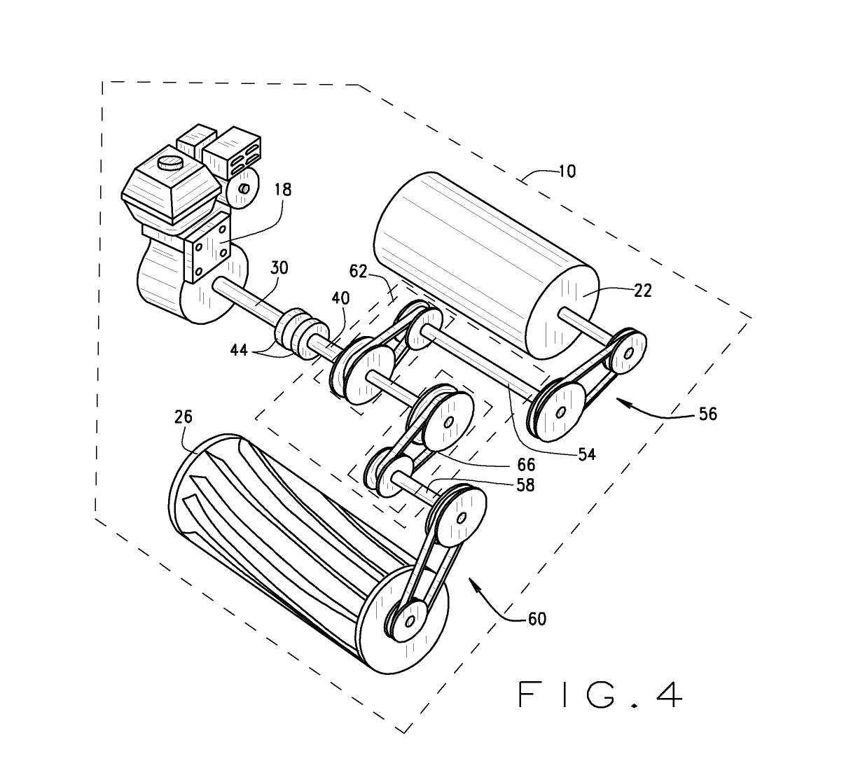

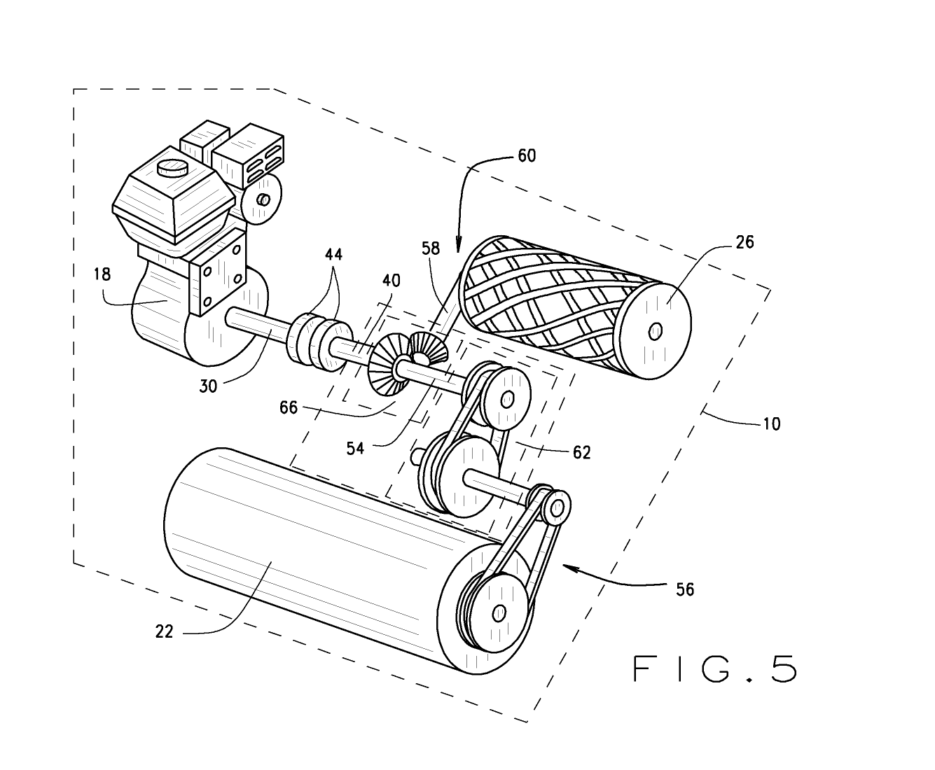

Referring now to FIGS. 4 and 5, as described above, at least one of the drum torque transfer assembly 62 and the reel torque transfer assembly 66 comprises a continuously variable transmission (CVT) hub, whereby power delivered by the power input shaft 40 is transferred to the drum and/or reel output shafts 54 and/or 58 at any selectable infinitely variable torque transfer ratio. For example, as exemplarily illustrated in FIG. 4, in various embodiments, the drum torque transfer assembly 62 comprises a CVT hub (referred to herein as the drum CVT hub 62) and the reel torque transfer assembly 66 comprises a CVT hub (referred to herein as the reel CVT hub 66). The drum CVT hub 62 operably connects, via the respective CVT internal torque transfer mechanism, the power input shaft 40 to the proximal end 54B of the drum output shaft 54. Furthermore, the drum CVT hub 62 is operable, as independently controlled by the power split device controller 70, to transfer torque and rotational speed from the power input shaft 40 to the drum output shaft 54 at any infinitely variable ratio such that the rotational speed of the drive drum is selectably adjustable. Similarly, the reel CVT hub 66 operably connects, via the respective CVT internal torque transfer mechanism, the power input shaft 40 to the proximal end 58B of the reel output shaft 58. Furthermore, the reel CVT 66 is operable, as independently controlled by the power split device controller 70, to transfer torque and rotational speed from the power input shaft 40 to the reel output shaft 58 at any infinitely variable ratio such that the rotational speed of the blade reel 26 is selectably adjustable.

As described above, the drum output shaft distal end 54A and the reel output shaft distal end 58A can be operatively connected to the respective drive drum 22 and blade reel 26 using any suitable torque transfer mechanism, device or system 56 and 60, e.g., a gear set, a geared transmission, a series of pulleys and belts, etc. In various implementations, one and/or both torque transfer mechanisms, devices or systems 56 and 60 can be structured and operable to transfer the torque and rotational speed delivered from the respective drum and reel output shaft distal ends 54A and 58A to the respective drive drum 22 and blade reel 26 (e.g., to axle shafts of the respective drive drum 22 and blade reel 26) at any desired fixed torque transfer ratio.

Referring now to FIG. 4, in operation, the user will input or select the desired FOC and/or desired forward travel speed via the controller user interface 70. Additionally, or alternatively, in some embodiments, a user can input a desired FOC and/or desired forward travel speed via an external communication device that can be in communication with the controller 70 via the I/O communication interface 102 or wireless communication means described herein. Based on the given mechanical configuration of the mower 10 (e.g., the number of cutting blades 38 on the blade reel 26), the power split device controller 70 will determine (e.g., based at least in part on execution of the torque distribution software) the appropriate rotational speed for the drive drum 22 and the corresponding rotational speed of the blade reel 26 needed to achieve the desired forward travel speed and FOC. The controller 70 will further determine (e.g., based at least in part on execution of the torque transfer software) the torque transfer ratio needed to transfer the amount of torque and rotational speed to the drum output shaft 54, via the drum CVT hub 62, needed to achieve the rotational speed of the drum drive 22 corresponding to the desired forward travel speed of the mower 10. Then, upon engagement of the power generator clutch mechanism 44, the controller 70 will actuate and control operation of the drum CVT hub 62 to provide the determined torque transfer ratio. Similarly, the controller 70 will determine (e.g., based at least in part on execution of the torque transfer software) the torque transfer ratio needed to transfer the amount of torque and rotational speed to the reel output shaft 58, via the reel CVT hub 66, needed to achieve the rotational speed of the blade reel 26 necessary to achieve the desired FOC, as a function of the desired forward travel speed of the mower 10. Then, upon engagement of the power generator clutch mechanism 44, the controller 70 will actuate and control operation of the reel CVT hub 66 to provide the determined torque transfer ratio.

It is envisioned that, by utilizing feedback sensor data during execution of the torque transfer software, the controller 70 can, in various embodiments, automatically adjust the drum CVT hub 62 and/or the reel CVT hub 66, to alter the drive drum rotational speed and/or the blade reel rotational speed to compensate for any power generator speed changes (e.g., load imposed RPM ‘droop’). Hence, the torque transfer ratio of the power split device 14 (i.e., the torque transfer ratios of the drum CVT hub 62 and the reel CVT hub 66) and the rotational speed output by the power generator 18 can be automatically controlled by the power split device controller 70 to ensure a steady forward travel speed and FOC of the mower 10 is maintained.

In various other embodiments, as exemplarily illustrated in FIG. 5, the drum torque transfer assembly 62 comprises a CVT hub (referred to herein as the drum CVT hub 62) and the reel torque transfer assembly 66 comprises a fixed ratio hub (referred to herein as the reel fixed ratio hub 66). The drum CVT hub 62 operably connects, via the respective CVT internal torque transfer mechanism, the power input shaft 40 to the proximal end 54B of the drum output shaft 54. Furthermore, the drum CVT hub 62 is operable, as independently controlled by the power split device controller 70, to transfer power from the power input shaft 40 to the drum output shaft 54 at any infinitely variable ratio such that the rotational speed of the drive drum 22 is selectably adjustable. The reel fixed ratio hub 66 operably connects the power input shaft 40 to the proximal end 58B of the reel output shaft 58 via a fixed ratio gear set, or other suitable fixed ratio torque transfer mechanism. The reel fixed ratio hub 66 is operable, as independently controlled by the power split device controller 70, to transfer torque from the power input shaft 40 to the reel output shaft 58 at a predetermined fixed ratio such that the rotational speed of the blade reel 26 is fixed as a function of the rotational speed of the power input shaft 40 and the torque transfer ratio of the reel fixed ratio hub 66.

As described above, the drum output shaft distal end 54A and the reel output shaft distal end 58A can be operatively connected to the respective drive drum 22 and blade reel 26 using any suitable torque transfer mechanism, device or system suitable 56 and 60, e.g., a gear set, a geared transmission, a series of pulleys and belts, etc. In various implementations, one and/or both torque transfer mechanisms, devices or systems 56 and 60 can be structured and operable to transfer the torque delivered from the respective drum and reel output shaft distal ends 54A and 58A to the respective drive drum 22 and blade reel 26 (e.g., to axle shafts of the respective drive drum 22 and blade reel 26) at any desired fixed torque input-to-output ratio.

In operation, the user will input the desired FOC via the controller user interface 90. Based on the given mechanical configuration of the mower 10 (e.g., the number of cutting blades 38 on the blade reel 26), the power split device controller 70 will determine (e.g., through execution of the torque transfer software) the fixed rotational speed of the blade reel 26 and the corresponding rotational speed for the drive drum 22 needed to achieve the desired FOC. More specifically, the controller 70 can be configured to determine the fixed rotational speed of the blade reel 26 that will result from the particular fixed gear ratio of the reel fixed ratio hub 66 and a particular rotational speed of the power input shaft 40 that corresponds to the operational speed of the power generator 18 and the power generator shaft 30, e.g., 2500-3000 RPMs. In various embodiments, the controller 70 will determine (e.g., via execution of the torque transfer software) the torque transfer ratio needed to transfer the amount of torque and rotational speed to the drum output shaft 54, via the drum CVT hub 62, necessary to achieve the rotational speed of the drum drive 22 that will provide the desired FOC as a function of the determined fixed rotational speed of the blade reel 26. Then, upon engagement of the power generator clutch mechanism 44, the controller 70 will actuate and control operation of the drum CVT hub 62 to provide the determined torque transfer ratio.

It is envisioned that, by utilizing feedback sensor data during execution of the torque transfer software, the controller 70 of some embodiments can automatically adjust the drum CVT hub 62 to alter the drive drum rotational speed to compensate for any power generator speed changes (e.g., load imposed RPM ‘droop’). Hence, the torque transfer ratios of the power split device 14 (i.e., the torque transfer ratios of the drum CVT hub 62 and the reel fixed ratio hub 66) and the rotational output by the power generator 18 can be automatically controlled by the power split device controller 70 to ensure a steady forward travel speed and FOC of the mower 10 is maintained.

Alternatively, in yet other embodiments, the reel torque transfer assembly 66 comprises a CVT hub (referred to herein as the reel CVT hub 66) and the drum torque transfer assembly 62 comprises a fixed ratio hub (referred to herein as the drum fixed ratio hub 62). Transposing the blade reel 26 and the drive drum 22 in FIG. 5 provides an exemplary illustration of such embodiments. In such embodiments, the reel CVT hub 66 operably connects, via the respective CVT internal torque transfer mechanism, the power input shaft 40 to the proximal end 58B of the reel output shaft 58. Furthermore, the reel CVT hub 66 is operable, as independently controlled by the power split device controller 70, to transfer torque and rotational speed from the power input shaft 40 to the reel output shaft 58 at any infinitely variable ratio, as function of the fixed rotational speed of the drive drum 22, such that the rotational speed of the blade reel 26, and hence the FOC, is selectably adjustable. The drum fixed ratio hub 62 operably connects the power input shaft 40 to the proximal end 54B of the drum output shaft 54 via a fixed ratio gear set, or other suitable fixed ratio torque transfer mechanism. The drum fixed ratio hub 62 is operable, as independently controlled by the power split device controller 70, to transfer torque and rotational speed from the power input shaft 40 to the drum output shaft 54 at a predetermined fixed ratio such that the rotational speed of the drive drum 26, and hence the forward travel speed of the mower 10, is fixed.

As described above, the drum output shaft distal end 54A and the reel output shaft distal end 58A can be operatively connected to the respective drive drum 22 and blade reel 26 using any suitable torque transfer mechanism, device or system suitable 56 and 60, e.g., a gear set, a geared transmission, a series of pulleys and belts, etc. In various implementations, one and/or both torque transfer mechanisms, devices or systems 56 and 60 can be structured and operable to transfer the torque and rotational speed delivered from the respective drum and reel output shaft distal ends 54A and 58A to the respective drive drum 22 and blade reel 26 (e.g., to axle shafts of the respective drive drum 22 and blade reel 26) at any desired fixed torque input-to-output ratio.

In operation, the user will input or select the desired FOC via the controller user interface 90. Based on the known fixed ratio of the drum fixed ratio hub 62 the controller 70 will determine, (e.g., based at least in part on execution of the torque transfer software) the rotational speed of the drive drum 22, and hence the forward travel speed of the mower 10, that will result from a particular rotational speed of the power input shaft 40 that corresponds to the operational speed of the power generator 18 and the power generator shaft 30, e.g., 2500-3000 RPMs. Subsequently, based on the determined rotational speed of the drive drum 22, the controller 70 will determine, via execution of the torque transfer software, the torque transfer ratio needed to transfer the amount of torque and rotational speed to the reel output shaft 58, via the reel CVT hub 66, necessary to achieve the rotational speed of the blade reel 26 that will provide the desired FOC. Then, upon engagement of the power generator clutch mechanism 44, the controller 70 will actuate and control operation of the reel CVT hub 66 to provide the determined torque transfer ratio.

It is envisioned that, by utilizing feedback sensor data during execution of the torque transfer software, the controller 70 of some embodiments can automatically adjust the reel CVT hub 66 to alter the rotational speed of the blade reel 26 to compensate for any power generator speed changes (e.g., load imposed RPM ‘droop’). Hence, the torque transfer ratios of the power split device 14 (i.e., the torque transfer ratios of the drum fixed ratio hub 62 and the reel CVT hub 66) and the rotational speed output by the power generator 18 can be automatically controlled by the power split device controller 70 to ensure a steady forward travel speed and FOC of the mower 10 is maintained.

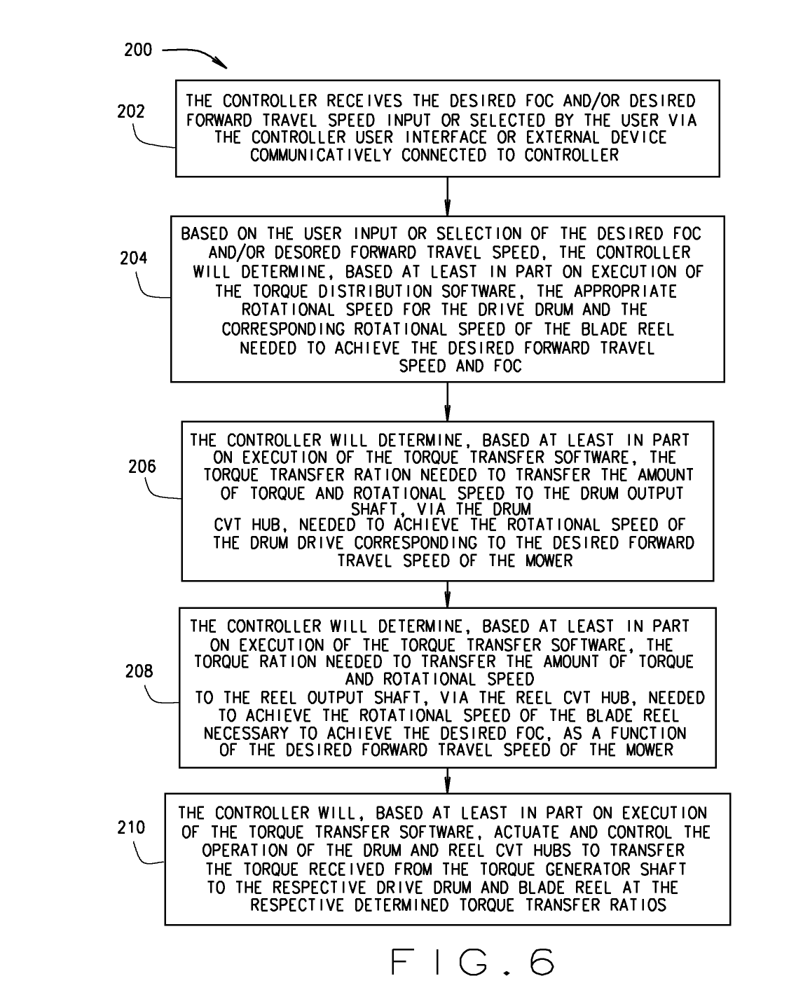

Referring now to FIGS. 4, 5, 6 and 7, as described above, the controller 70 controls the torque and rotational speed output to the drive drum 22 and the blade real 26, and the corresponding torque ratio. For example, as exemplarily illustrated in the flow chart 200 of FIG. 6, in the embodiments wherein both the drum and reel torque transfer assemblies 62 and 66 comprise CVT hubs (shown in FIG. 4), the controller 70 receives the desired FOC and/or desired forward travel speed input or selected by the user via the controller user interface 70 or external device communicatively connected (wired and/or wirelessly) to controller 70, as illustrated at 202. Then, based on the given mechanical configuration of the mower 10 (e.g., the number of cutting blades 38 on the blade reel 26), the controller 70 will determine, based at least in part on execution of the torque distribution software, the appropriate rotational speed for the drive drum 22 and the corresponding rotational speed of the blade reel 26 needed to achieve the desired forward travel speed and FOC, as illustrated in 204. The controller 70 will further determine, based at least in part on execution of the torque transfer software, the torque transfer ratio needed to transfer the amount of torque and rotational speed to the drum output shaft 54, via the drum CVT hub 62, needed to achieve the rotational speed of the drum drive 22 corresponding to the desired forward travel speed of the mower 10, as illustrated at 206. Similarly, based at least in part on execution of the torque transfer software, the controller 70 will determine the torque transfer ratio needed to transfer the amount of torque and rotational speed to the reel output shaft 58, via the reel CVT hub 66, needed to achieve the rotational speed of the blade reel 26 necessary to achieve the desired FOC, as a function of the desired forward travel speed of the mower 10, as illustrated at 208. Finally, the controller will, based at least in part on execution of the torque transfer software, actuate and control the operation of the drum and reel CVT hubs 62 and 66 to transfer the torque and rotational speed received from the power generator shaft 30 to the respective drive drum 22 and blade reel 26 at the respective determined torque transfer ratios, as indicated at 210.

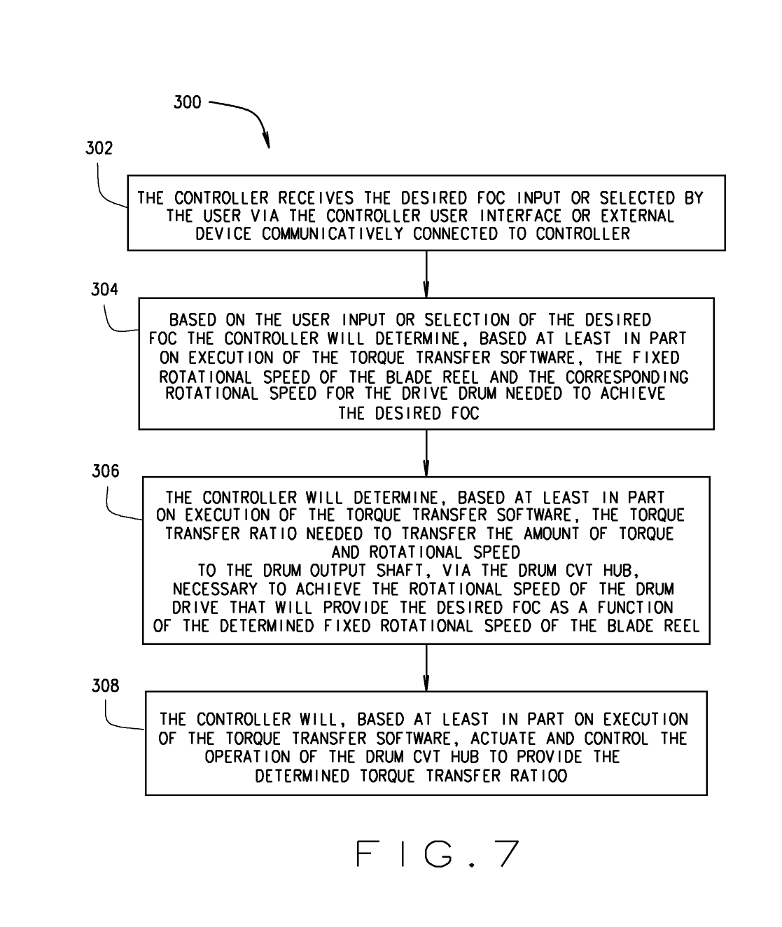

Alternatively, as exemplarily illustrated in the flow chart 300 of FIG. 7, in the embodiments wherein the drum torque transfer assembly 62 comprises a CVT hub and the reel torque transfer assembly 66 comprises a fixed ratio hub (shown in FIG. 5), the controller 70 receives the desired FOC input or selected by the user via the controller user interface 70 or external device communicatively connected (wired and/or wirelessly) to controller 70, as illustrated at 302. Then based on the given mechanical configuration of the mower 10 (e.g., the number of cutting blades 38 on the blade reel 26), the power split device controller 70 will determine, based at least in part on execution of the torque transfer software, the fixed rotational speed of the blade reel 26 and the corresponding rotational speed for the drive drum 22 needed to achieve the desired FOC, as illustrated at 304. The controller 70 will further determine, based at least in part on execution of the torque transfer software, the torque transfer ratio needed to transfer the amount of torque and rotational speed to the drum output shaft 54, via the drum CVT hub 62, necessary to achieve the rotational speed of the drum drive 22 that will provide the desired FOC as a function of the determined fixed rotational speed of the blade reel 26, as illustrated at 306. Subsequently, controller 70 will, based at least in part on execution of the torque transfer software, actuate and control the operation of the drum CVT hub 62 to provide the determined torque transfer ratio, as indicated at 308.

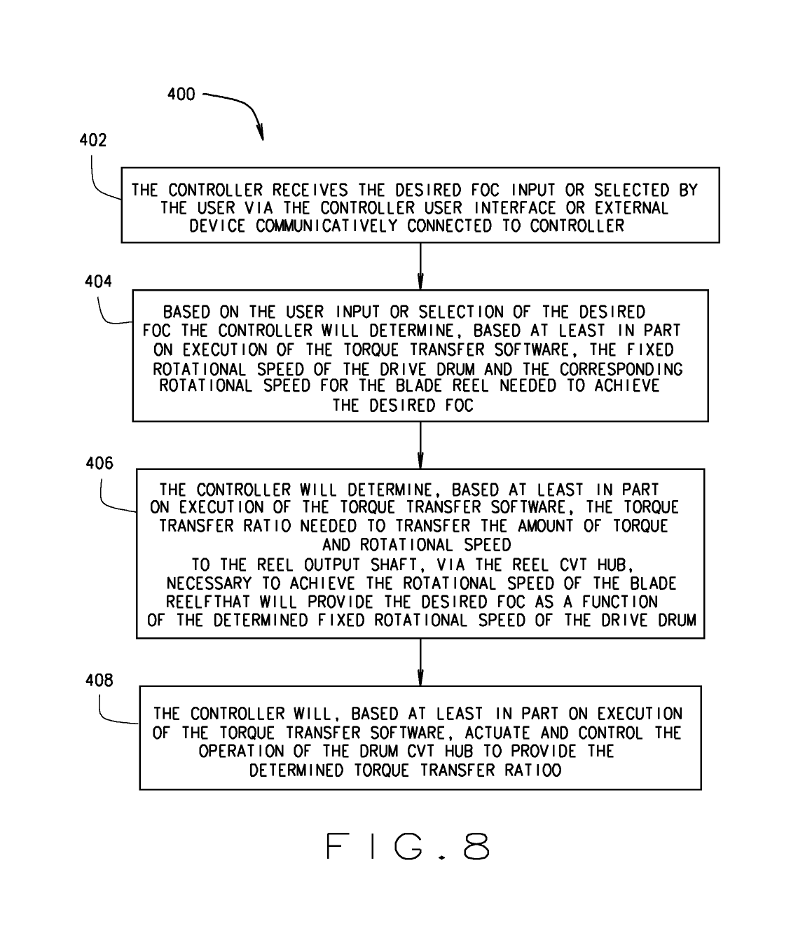

Still further, as exemplarily illustrated in the flow chart 400 of FIG. 8, in the embodiments wherein the reel torque transfer assembly 66 comprises a CVT hub and the drum torque transfer assembly 62 comprises a fixed ratio hub (as described above as an alternative embodiment of FIG. 5), the controller 70 receives the desired FOC input or selected by the user via the controller user interface 70 or external device communicatively connected (wired and/or wirelessly) to controller 70, as illustrated at 402. Then based on the given mechanical configuration of the mower 10 (e.g., the number of cutting blades 38 on the blade reel 26), the power split device controller 70 will determine, based at least in part on execution of the torque transfer software, the fixed rotational speed of the drive drum 22 and the corresponding rotational speed for the blade reel 22 needed to achieve the desired FOC as a function of the determined fixed rotational speed of the drive drum, as indicated at 404. Subsequently, controller 70 will, based at least in part on execution of the torque transfer software, actuate and control the operation of the reel CVT hub 66 to provide the determined torque transfer ratio, as indicated at 408.

It is envisioned that the power split device 14, as described above, can be implemented in a riding mower wherein the drive drum 22 is replaced by one or more traction wheels of the mower, and the mower includes a plurality of blade reels 26. In such embodiments, the power split device 14 would be structured and operable to controllably distribute torque and rotational speed from the single power generator 18 to either or both of the at least one traction wheel and the plurality of blade reels 26 via one or more respective drum CVT hubs 62 and/or one or more respective reel CVT hubs 66. Optionally, at least one of the at least one traction wheel and the plurality of blade reels 26 can be driven via a respective one or more fixed ratio hubs, as described above.

The description herein is merely exemplary in nature and, thus, variations that do not depart from the gist of that which is described are intended to be within the scope of the teachings. Such variations are not to be regarded as a departure from the spirit and scope of the teachings. Therefore, it is to be understood that the embodiments of the present disclosure are not to be limited to the specific embodiments disclosed and that modifications and other embodiments are intended to be included within the scope of the disclosure. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the disclosure.

What is claimed is:

1. A grass mower, said mower comprising:
a power generator;
a blade reel;
a drive drum; and
a power split device comprising:
a single power input shaft operably connectable to the power generator;
a reel output shaft operably connected at a distal end to the blade reel;
a drum output shaft operably connected at a distal end to the drive drum; and
at least one continuously variable transmission (CVT) hub operably connecting at least one of a proximal end of the reel output shaft and a proximal end of the drum output shaft to the power input shaft such that torque and rotational speed delivered by the power input shaft is transferrable to the at least one of the reel and drum output shafts at any infinitely variable ratio;
wherein, the power split device is structured and operable to transfer the torque and rotational speed delivered by the power input shaft to both the reel and drum output shafts such that a rotational speed of the blade reel and a rotational speed of the drive drum are both generated from the power delivered by the power input shaft and are both independently controlled.

2. The mower of claim 1, wherein the at least one CVT hub comprises:
a reel CVT hub operably connecting the power input shaft to the proximal end of the reel output shaft such that torque and rotational speed delivered by the power input shaft is transferrable to the reel output shaft at any infinitely variable ratio such that the rotational speed of the blade reel is selectably adjustable; and
a drum CVT hub operably connecting the power input shaft to the proximal end of the drum output shaft, such that torque and rotational speed delivered by the power input shaft is transferrable to the drum output shaft at any infinitely variable ratio such that the rotational speed of the drive drum is selectably adjustable.

3. The mower of claim 2, wherein the power split device further comprises a reel clutch mechanism structured and operable to engage and disengage the delivery of torque and rotational speed from the power input shaft to the reel output shaft.

4. The mower of claim 1, wherein,
the at least one CVT hub comprises a drum CVT hub operably connecting the power input shaft to proximal end of the drum output shaft such that torque and rotational speed delivered by the power input shaft is transferrable to the drum output shaft at any infinitely variable ratio such that the rotational speed of the drive drum is selectably adjustable, and
the power split device further comprises a fixed ratio reel torque transfer assembly operably connecting the power input shaft to proximal end of the reel output shaft, the fixed ratio reel torque transfer assembly structured and operable to transfer the torque and rotational speed delivered by the power input shaft to the reel output shaft at a fixed ratio such that the rotational speed of the blade reel is substantially fixed.

5. The mower of claim 4, wherein the power split device further comprises a reel clutch mechanism structured and operable to engage and disengage the delivery of power from the power input shaft to the reel output shaft.

6. The mower of claim 1, wherein,
the at least one CVT hub comprises a reel CVT hub operably connecting the power input shaft to proximal end of the reel output shaft such that torque and rotational speed delivered by the power input shaft is transferrable to the reel output shaft at any infinitely variable ratio such that the rotational speed of the drive drum is selectably adjustable, and
the power split device further comprises a fixed ratio drum torque transfer assembly operably connecting the power input shaft to proximal end of the drum output shaft, the fixed ratio drum torque transfer assembly structured and operable to transfer the torque and rotational speed delivered by the power input shaft to the drum output shaft at a fixed ratio such that the rotational speed of the drive drum is substantially fixed.

7. A method for independently controlling the rotation speed of a blade reel and a drive drum of grass mower utilizing single power input, said method comprising:
engaging a power generator transfer shaft of a mower with a single power input shaft of a power split device of the mower, thereby transferring torque and rotational speed generated by the power generator to the power input shaft;
transferring the torque and rotational speed, at any infinitely variable ratio, from the power input shaft to the at least one of a reel output shaft of the power split device that is operably connected at a distal end to a blade reel of the mower, and a drum output shaft of the power split device that operably connected at a distal end to a drive drum of the mower, utilizing at least one continuously variable transmission (CVT) hub operably connecting at least one of a proximal end of the reel output shaft and a proximal end of the drum output shaft to the power input shaft.

8. The method of claim 7, wherein the at least one CVT hub comprises a reel CVT hub operably connecting the power input shaft to the proximal end of the reel output shaft; and a drum CVT hub operably connecting the power input shaft to proximal end of the drum output shaft, and wherein transferring the torque and rotational speed, at any infinitely variable ratio, from the power input shaft comprises:
transferring torque and rotational speed delivered by the power input shaft to the reel output shaft at any infinitely variable ratio, utilizing the reel CVT hub, such that the rotational speed of the blade reel is selectably adjustable; and
transferring torque and rotational speed delivered by the power input shaft to the drum output shaft at any infinitely variable ratio, utilizing the drum CVT hub, such that the rotational speed of the drive drum is selectably adjustable.

9. The method of claim 8, wherein the power split device further comprises a reel clutch mechanism, and wherein transferring the power, at any infinitely variable ratio, from the power input shaft further comprises engaging the reel clutch mechanism to transfer torque and rotational speed from the power input shaft to the reel output shaft.

10. The method of claim 7, wherein the at least one CVT hub comprises a drum CVT hub operably connecting the power input shaft to proximal end of the drum output shaft, and the power split device further comprises a fixed ratio reel torque transfer assembly operably connecting the power input shaft to the proximal end of the reel output shaft, and wherein transferring the torque and rotational speed, at any infinitely variable ratio, from the power input shaft comprises:
transferring torque and rotational speed delivered by the power input shaft to the drum output shaft at any infinitely variable ratio, utilizing the drum CVT, such that the rotational speed of the drive drum is selectably adjustable, and
transferring torque and rotational speed delivered by the power input shaft transfer to the reel output shaft at a fixed ratio, utilizing the fixed ratio reel torque transfer assembly, such that the rotational speed of the blade reel is substantially fixed.

11. The method of claim 10, wherein the power split device further comprises a reel clutch mechanism structured and operable to engage and disengage the delivery of power from the power input shaft to the reel output shaft.

12. The method of claim 7, wherein the at least one CVT hub comprises a reel CVT hub operably connecting the power input shaft to proximal end of the reel output shaft, and the power split device further comprises a fixed ratio drum torque transfer assembly operably connecting the power input shaft to the proximal end of the drum output shaft, and wherein transferring the torque and rotational speed, at any infinitely variable ratio, from the power input shaft comprises:
transferring torque and rotational speed delivered by the power input shaft to the reel output shaft at any infinitely variable ratio, utilizing the reel CVT, such that the rotational speed of the blade reel is selectably adjustable, and
transferring torque and rotational speed delivered by the power input shaft transfer to the drum output shaft at a fixed ratio, utilizing the fixed ratio drum torque transfer assembly, such that the rotational speed of the drive drum is substantially fixed.

13. A grass mower, said mower comprising:
a power generator;
a blade reel;
a drive drum; and
a power split device comprising:
a single power input shaft operably connectable to the power generator;
a reel output shaft operably connected at a distal end to the blade reel;
a drum output shaft operably connected at a distal end to the drive drum;
at least one continuously variable transmission (CVT) hub operably connecting at least one of a proximal end of the reel output shaft and a proximal end of the drum output shaft to the power input shaft such that torque and rotational speed delivered by the power input shaft is transferrable to the at least one of the reel and drum output shafts at any infinitely variable ratio; and
a reel clutch mechanism structured and operable to engage and disengage the delivery of power from the power input shaft to the reel output shaft.
wherein, the power split device is structured and operable to transfer the torque and rotational speed delivered by the power input shaft to both the reel and drum output shafts such that a rotational speed of the blade reel and a rotational speed of the drive drum are both generated from the power delivered by the power input shaft and are both independently controlled.

14. The mower of claim 13, wherein the at least one CVT hub comprises:
a reel CVT hub operably connecting the power input shaft to the proximal end of the reel output shaft such that torque and rotational speed delivered by the power input shaft is transferrable to the reel output shaft at any infinitely variable ratio such that the rotational speed of the blade reel is selectably adjustable; and
a drum CVT hub operably connecting the power input shaft to proximal end of the drum output shaft, such that torque and rotational speed delivered by the power input shaft is transferrable to the drum output shaft at any infinitely variable ratio such that the rotational speed of the drive drum is selectably adjustable.

15. The mower of claim 13, wherein,
the at least one CVT hub comprises a drum CVT hub operably connecting the power input shaft to proximal end of the drum output shaft such that torque and rotational speed delivered by the power input shaft is transferrable to the drum output shaft at any infinitely variable ratio such that the rotational speed of the drive drum is selectably adjustable, and
the power split device further comprises a fixed ratio reel torque transfer assembly operably connecting the power input shaft to proximal end of the reel output shaft, the fixed ratio reel torque transfer assembly structured and operable to transfer the torque and rotational speed delivered by the power input shaft to the reel output shaft at a fixed ratio such that the rotational speed of the blade reel is substantially fixed.

16. The mower of claim 13, wherein,
the at least one CVT hub comprises a reel CVT hub operably connecting the power input shaft to proximal end of the reel output shaft such that torque and rotational speed delivered by the power input shaft is transferrable to the reel output shaft at any infinitely variable ratio such that the rotational speed of the drive drum is selectably adjustable, and
the power split device further comprises a fixed ratio drum torque transfer assembly operably connecting the power input shaft to proximal end of the drum output shaft, the fixed ratio drum torque transfer assembly structured and operable to transfer the torque and rotational speed delivered by the power input shaft to the drum output shaft at a fixed ratio such that the rotational speed of the drive drum is substantially fixed.
